(19) United States
(12) Patent Application Publication
(10) Pub. No.: US 2006/0089097 A1
(43) Pub. Date: Apr. 27, 2006

(54) Method and system for managing digital satellite content for broadcast to a target fleet

(75) Inventors: Mingheng Wang, Rochester Hills, MI (US); Steven J. Ross, Livonia, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/970,935

(22) Filed: Oct. 22, 2004

(51) Int. Cl. H04H 1/00

(52) U.S. Cl. 455/3.02

(57) ABSTRACT

A method of managing digital satellite content for delivery to a target fleet is provided. At least one member of the target fleet is identified. Digital satellite content to be transmitted is determined and addressed to the identified member of the target fleet. The digital satellite content is then transmitted. A system and computer program for managing digital satellite content are also provided.

### FIELD OF THE INVENTION

This invention relates generally to broadcasting digital satellite content over a wireless communication system. More specifically, the invention relates to a method and system for managing digital satellite content for broadcast to a fleet of mobile vehicles or devices.

### BACKGROUND OF THE INVENTION

Satellite delivery of digital content has better coverage than delivery of content over a cellular network. The term “digital satellite content” includes but is not limited to any text data, image data, computer programs, vehicle configuration parameters, and audio data as well as attachments to messages that may be broadcast via satellite. Thus, digital satellite content (DSC) may be broadcast over a wider area than a cellular network. Existing mobile vehicle communication systems are equipped to receive and manage cellular network-based content for broadcast to mobile vehicles. Currently, such a system is able to broadcast DSC one message to one vehicle at a time.

In some instances, it is necessary to send DSC to a number of mobile vehicles. For example, updates to the entire mobile vehicle communication system would require broadcasting the DSC to all subscriber vehicles in the fleet. Also in some instances, DSC comprising commands controlled at a central location require broadcasting to a number of vehicles in a fleet. In another example, third-party information targeted at several, but perhaps not all members, of the fleet would also require broadcasting the DSC to a number of vehicles. Finally, it is also necessary to manage individual subscriber DSC, such as personal greetings, sent to one or more mobile vehicle members of the fleet. Such broadcasting of DSC would be enabled by the ability to store the DSC within the mobile vehicle communication system, the ability to uniquely identify and classify the DSC and the ability to selectively manage and broadcast the DSC based on such parameters as geographic area, temporal area and class of vehicle.

Accordingly, it would be desirable to have a system and method for managing digital satellite content using a mobile vehicle communication system. It would further be desirable to have a system and method for managing digital satellite content for broadcast to a fleet of vehicles or devices that are subscribed to a mobile vehicle communication network. It is an object of this invention, therefore, to provide a method for managing digital satellite content, and to overcome the deficiencies and obstacles described above.

### SUMMARY OF THE INVENTION

One aspect of the invention is a method for managing digital satellite content for delivery to a target fleet. At least one member of the target fleet is identified. DSC to be transmitted to the target fleet is determined and addressed to the identified member of the target fleet, for example by encoding the DSC with an identifier that indicates the identifier member. The DSC is then transmitted. The DSC may then be received at a DSC receiver, stored in a dedicated content broadcast database or deleted. It may further be determined whether the DSC is expired. A start time and duration for transmitting the DSC may also be determined.

Another aspect of the invention is a system for managing digital satellite content for delivery to a target fleet. The system comprises means for identifying at least one member of the target fleet, means for determining the DSC to be transmitted to the target fleet, means for addressing the DSC to the identified member of the target fleet and means for transmitting the DSC. The system may also include means for receiving the DSC, for storing the DSC and for determining whether the DSC is expired. The system may also include means for determining a start time and duration for transmitting the DSC.

Yet another aspect of the present invention comprises a computer usable medium including a program for managing digital satellite content for delivery to a target fleet. The program comprises code that identifies at least one member of the target fleet, code that determines the DSC to be transmitted to the target fleet, code that addresses the DSC to the identified member of the target fleet and code that transmits the DSC. The system may also include code that receives the DSC, that stores the DSC and that determines whether the DSC is expired. The system may also include code that determines a start time and duration for transmitting the DSC.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a mobile vehicle communication system for managing digital satellite content using a mobile vehicle communication system, in accordance with one embodiment of the current invention;

FIG. 2 illustrates a system for managing digital satellite content using a mobile vehicle communication system, in accordance with another embodiment of the current invention;

FIG. 3 illustrates a method of managing digital satellite content, in accordance with one embodiment of the current invention; and

FIG. 4 illustrates a user interface for managing digital satellite content, in accordance with another embodiment of the current invention.

### DETAILED DESCRIPTION OF THE PRESENTLY PREFERRED EMBODIMENTS

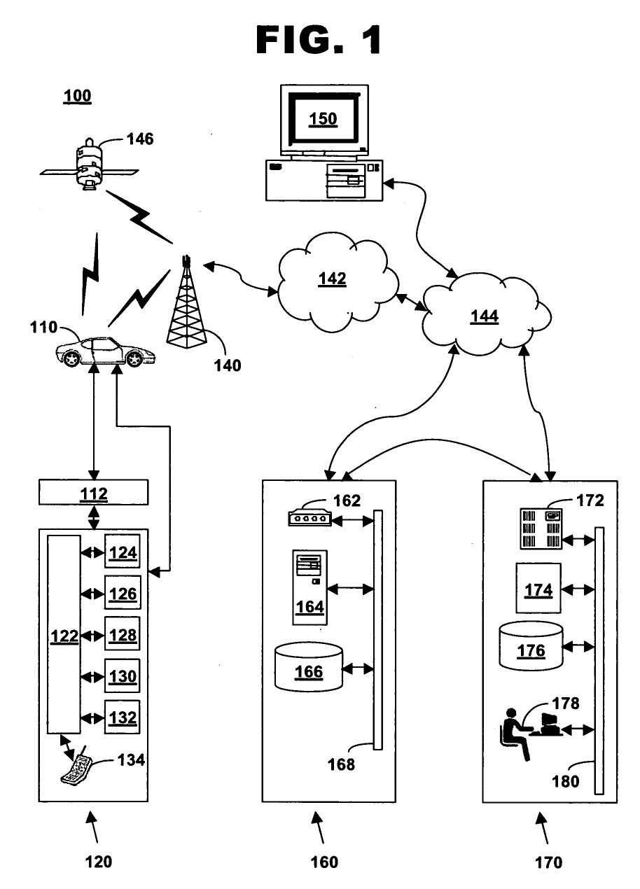

FIG. 1 illustrates one embodiment of a mobile vehicle communication system (MVCS) 100 for controlling vehicle modules. MVCS 100 includes a mobile vehicle communication unit (MVCU) 110, a vehicle communication network 112, a telematics unit 120, one or more wireless carrier systems 140, one or more communication networks 142, one or more land networks 144, one or more satellite broadcast systems 146, one or more client, personal, or user computers 150, one or more web-hosting portals 160, and one or more vehicle call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, activating a remote alert (e.g. honking the horn and/or flashing the lights), setting personal comfort settings, and calling from telematics unit 120. These functions are performed by sending electronic instructions to a vehicle module configured to perform a certain task or function. In facilitating interactions among the various communication and electronic modules, vehicle communication network 112 utilizes network interfaces such as controller-area network, International Organization for Standardization (ISO) Standard 9141, ISO Standard 11898 for high-speed applications, ISO Standard 11519 for lower speed applications, and Society of Automotive Engineers Standard J1850 for high-speed and lower speed applications.

MVCU 110, via telematics unit 120, sends to and receives radio transmissions from wireless carrier system 140. Wireless carrier system 140 is implemented as any suitable system for transmitting a signal from MVCU 110 to communication network 142. MVCU 110 may also send and receive DSC from satellite broadcast system 146. In accordance with the present invention, MVCU 110 may contain unique embedded identification information that allows satellite broadcast system 146 to match content sent to MVCU 110 properly.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. Telematics unit 120 may include additional components not relevant to the present discussion. Telematics unit 120 is one example of a vehicle module.

In one embodiment, processor 122 is implemented as a microcontroller, controller, host processor, or vehicle communications processor. In one embodiment, processor 122 is a digital signal processor. In another embodiment, processor 122 is implemented as an application-specific integrated circuit. In another embodiment, processor 122 is implemented as a processor working in conjunction with a central processing unit performing the function of a general-purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode, or multi-band cellular phone.

Processor 122 executes various computer programs that control programming and operational modes of electronic and mechanical systems within MVCU 110. Processor 122 controls communications (e.g., call signals) between telematics unit 120, wireless carrier system 140, and vehicle call center 170. Additionally, processor 122 controls reception of communications from satellite broadcast system 146. In one embodiment, processor 122 receives DSC from satellite broadcast system 146 in accordance with the method described further below.

In one embodiment, a voice-recognition application is installed in processor 122 that can translate human voice input through microphone 130 to digital signals. Processor 122 generates and accepts digital signals transmitted between telematics unit 120 and vehicle communication network 112 that is connected to various electronic modules in the vehicle. In one embodiment, these digital signals activate programming modes and operation modes, as well as provide for data transfers such as, for example, data over voice channel communication. In this embodiment, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signals over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In one example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band of 2.3 GHz that has been allocated by the U.S. Federal Communications Commission for nationwide broadcasting of satellite-based Digital Audio Radio Service (SDARS).

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by vehicle call center 170. In an example, processor 122 implements data packets received by telematics unit 120. In yet another embodiment, DSC broadcast by satellite broadcast system 146 is managed using the method of the present invention so that DSC to be processed by processor 122 is first matched to MVCU 110 using information attached to the DSC which identifies MVCU 110 as a target vehicle or device.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to computer 150, web-hosting portal 160, and vehicle call center 170. In one embodiment, land network 144 is a public-switched telephone network. In another embodiment, land network 144 is implemented as an Internet protocol (IP) network. In other embodiments, land network 144 is implemented as a wired network, an optical network, a fiber network, a wireless network, or a combination thereof. Land network 144 is connected to one or more landline telephones. Communication network 142 and land network 144 connect wireless carrier system 140 to web-hosting portal 160 and vehicle call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Computer 150 sends user preferences to web-hosting portal 160 through a web-page interface using communication standards such as hypertext transport protocol, or transport-control protocol and Internet protocol. In one embodiment, the data includes directives to change certain programming and operational modes of electronic and mechanical systems within MVCU 110.

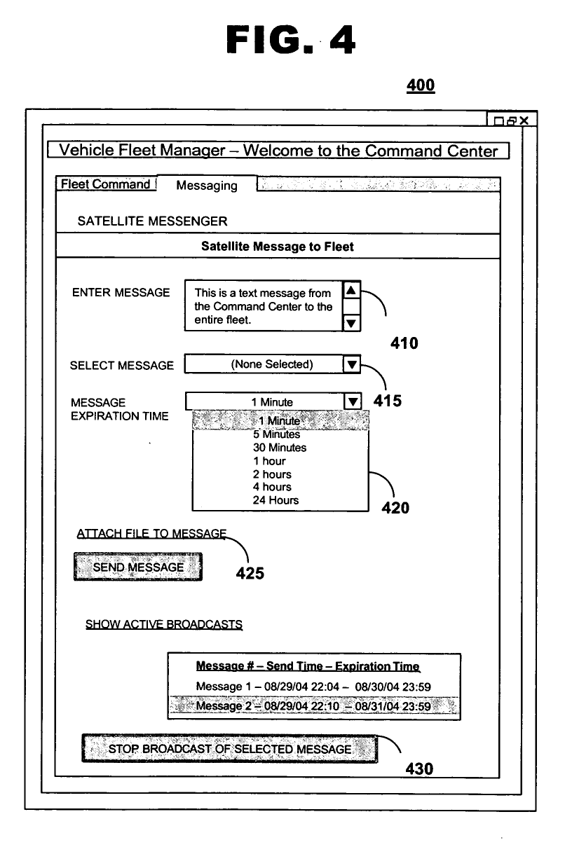

In operation, a client utilizes computer 150 to initiate setting or re-setting of user preferences for MVCU 110. For example, the client may be able to initiate settings for filtering the DSC to be received by telematics unit 120. Thus a client may enter user preference data regarding the type of DSC to be received. As further detailed in FIG. 4, the same or a different user may enter the actual DSC, the start time of broadcasting the DSC and a duration for broadcasting the DSC. User-preference data from client-side software is transmitted to server-side software of web-hosting portal 160. In an example, user-preference data is stored at web-hosting portal 160.

Web-hosting portal 160 includes one or more data modems 162, one or more web servers 164, one or more databases 166, and a network system 168. Web-hosting portal 160 is connected directly by wire to vehicle call center 170, or connected by phone lines to land network 144, which is connected to vehicle call center 170. In an example, web-hosting portal 160 is connected to vehicle call center 170 utilizing an IP network. In this example, both components, web-hosting portal 160 and vehicle call center 170, are connected to land network 144 utilizing the IP network. In another example, web-hosting portal 160 is connected to land network 144 by one or more data modems 162. Land network 144 sends digital data to and receives digital data from data modem 162, data that is then transferred to web server 164. Data modem 162 may reside inside web server 164. Land network 144 transmits data communications between web-hosting portal 160 and vehicle call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, and theft alarm settings. In accordance with the present invention, web server 164 may also include computer applications and files for managing and storing personalized DSC supplied by the client, such as birthday greetings and personal reminders. For each client, the web server potentially stores hundreds of preferences for wireless vehicle communication, networking, maintenance, and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to vehicle call center 170 through land network 144.

Vehicle call center 170 is a location where many calls are received and serviced at the same time, or where many calls are sent at the same time. In one example, the call center is a telematics call center, facilitating communications to and from telematics unit 120 in MVCU 110. In another example, the call center is a voice call center, providing verbal communications between an advisor in the call center and a subscriber in a mobile vehicle. In another example, the call center contains each of these functions. In other embodiments, vehicle call center 170 and web-hosting portal 160 are located in the same or different facilities.

Vehicle call center 170 contains one or more voice and data switches 172, one or more communication services managers 174, one or more communication services databases 176, one or more communication services advisors 178, and one or more network systems 180.

Switch 172 of vehicle call center 170 connects to land network 144. Switch 172 transmits voice or data transmissions from vehicle call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services including initiating data over voice channel wireless communication, enrollment services, navigation assistance, directory assistance, roadside assistance, business or residential assistance, information services assistance, emergency assistance, communications assistance and DSC management. Communication services manager 174 receives service-preference requests for a variety of services from the client via computer 150, web-hosting portal 160, and land network 144. Communication services manager 174 transmits user-preference and other data such as, for example, primary diagnostic script to telematics unit 120 in MVCU 110 through wireless carrier system 140, communication network 142, land network 144, voice and data switch 172, and network system 180. Communication services manager 174 may serve to manage DSC in accordance with the present invention. Communication services manager 174 stores or retrieves data and information from communication services database 176. Communication services database 176 may store DSC in accordance with the present invention. Communication services manager 174 may provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from vehicle call center 170. In one embodiment, the call is routed to telematics unit 120 from vehicle call center 170 via land network 144, communication network 142, and wireless carrier system 140. In another embodiment, an outbound communication is routed to telematics unit 120 from vehicle call center 170 via land network 144, communication network 142, wireless carrier system 140, and satellite broadcast system 146. In this embodiment, an inbound communication is routed to vehicle call center 170 from telematics unit 120 via wireless carrier system 140, communication network 142, and land network 144.

In accordance with one embodiment of the present invention, MVCS 100 serves as a system for managing DSC to be broadcast to a fleet of one or more MVCUs 110 or mobile devices. MVCUs 110 include a DSC receiver.

Processor 122 makes a determination whether to play received DSC based on whether there is a match between identifying information about the content receiver and identifying information attached to the DSC. Speakers 132, a visual display such as a liquid-crystal display (LCD), or other in-vehicle audio or visual device may be used to play the DSC based on the determination. For example, a text message including a “return to home base immediately” command may be played or displayed to an occupant in the mobile vehicle.

A play-delay indicator may be included with the DSC to allow storage of the content in memory at the mobile vehicle in response to the play-delay indicator. The play-delay indicator, when set, allows the message to be stored to allow an occupant in the mobile vehicle to hear or see the content when prompted by the occupant using, for example, a button on a radio, entertainment console, or telematics unit 120.

To establish a particular group or class of mobile vehicles or mobile devices for receiving DSC, one or more customer data records stored in communication services database 176 at vehicle call center 170 may be filtered to determine the target fleet. Thus the term “target fleet” includes, but is not limited to a fleet of mobile vehicles, a fleet of mobile devices and/or a mixture thereof. The vehicles or devices to be included in the target fleet may also be filtered at the user interface. After a target fleet is determined, the DSC is processed to address the content to the target fleet. In one embodiment, identifying information describing the target content receiver(s) is attached to the DSC including, for example, a set or string of one or more vehicle identification numbers associated with the target fleet is compiled and sent with the digital satellite content to a satellite radio broadcaster for transmitting the DSC to one or more targeted mobile vehicles or devices from satellite broadcast system 146.

Computer program code containing suitable instructions to send the DSC to the targeted mobile vehicles or devices may reside in part at vehicle call center 170, satellite broadcast system 146, MVCU 110, or telematics unit 120. For example, a program including computer program code to receive the DSC with the content receiver tag, program code to determine whether to play the content, and program code for playing the content may reside within processor 122 or within in-vehicle memory 128 so that processor 122 may execute the program instructions accordingly. The program may include code to receive a play-delay indicator and program code to store the content at the mobile vehicle in response to the play-delay indicator. The program may also include code to delete the content at the user's discretion.

A program residing within vehicle call center 170 may include computer program code to determine a target fleet of mobile vehicles and devices, program code to determine a content receiver tag associated with the target fleet, and program code to address the DSC with the content receiver tag, and program code for sending the DSC from the call center to a satellite radio broadcaster for transmitting the satellite broadcast message to one or more vehicles in the target group. For example, one or more customer data records stored in communication services database 176 at vehicle call center 170 may be filtered electronically to determine the target group of mobile vehicles.

Code to send the DSC including information identifying the members of the target fleet may reside within satellite broadcast system 146 in accordance with communication protocols of the satellite-radio broadcaster.

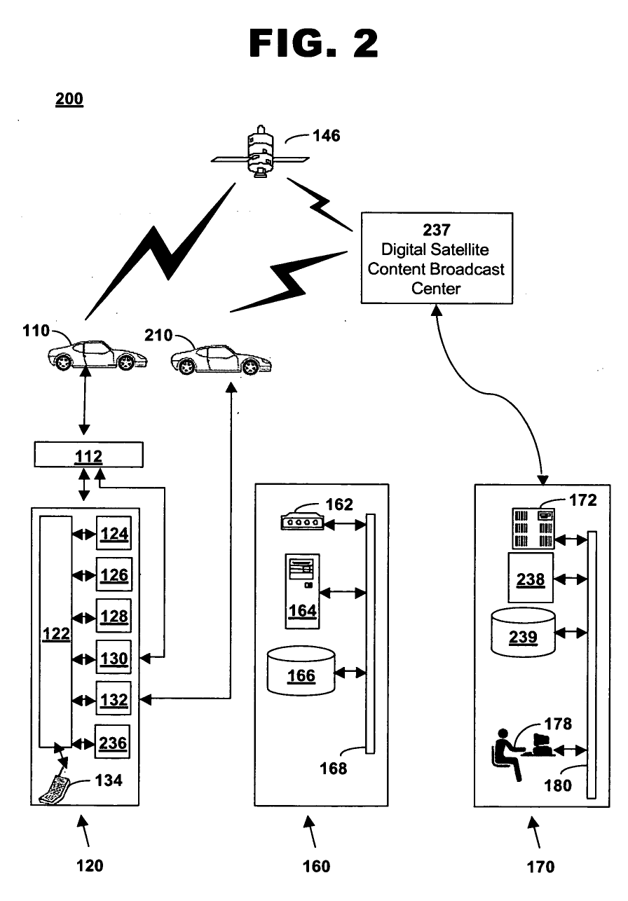

FIG. 2 illustrates a DSC management system 200 in accordance with another embodiment of the current invention. The components shown in FIG. 2 may also be used in conjunction with one or more of the components of mobile vehicle communication system 100 above.

DSC management system 200 includes a telematics unit 120, a web hosting portal 160 and vehicle call center 170, as well as one or more of their separate components, as described above. DSC management system 200 further comprises one or more digital satellites 146, one or more DSC receivers 236 in MVCUs 110, 210, at least one DSC broadcast center 237, at least one DSC manager 238 and at last one DSC database 239.

DSC receiver 236 receives the DSC. As FIG. 2 shows, The DSC receiver 236 may receive digital satellite-radio broadcast signals directly from, for example, a terrestrial radio transmitter or a satellite radio service geostationary satellite. In accordance with the present invention, receiver 236 may also receive DSC from DSC broadcast center 237. Receiver 236 may be included in MVCUs 110, 210. Alternatively, receiver 236 may be included in any suitable portable mobile device, such as a mobile phone, or PDA. The DSC receiver 236 may receive broadcast radio information over one or more channels and generate an audio output or provide data communications from the satellite service provider.

Satellite content receiver 236 may be physically separated from telematics unit 120 though electronically connected to the unit with a cable or over the vehicle communication network 112, or may be embedded within telematics unit 120. In accordance with the present invention, DSC receiver 236 monitors, filters, and sends signals that are received from satellite broadcasts, radio broadcasts, or other wireless communication systems to output devices such as speaker 132 and visual display devices (not shown). In one embodiment, DSC is processed using text-to-speech software so that the DSC is presented as speech to the target user(s) of MVCUs 110, 210.

Digital content management system 200 may also comprise one or more digital satellite broadcast centers 237. In addition to music and entertainment, traffic information, road construction information, advertisements, news and information on local events, DSC broadcast center 237 may send DSC that has been processed by digital content management system 200 to DSC receiver 236. Processing by digital content management system 200 addresses the DSC to specific DSC receivers. DSC broadcast center 237 may be a digital satellite or a broadcast center equipped to broadcast satellite or radio signals as described above.

A computer application at the DSC broadcast center 237 may control the sending of signals and data that are received from system 200 by using a predetermined broadcast channel. The signals may be transmitted, for example, over a spectrum allocated for nationwide broadcasting of satellite-based Digital Audio Radio Service. The satellite radio broadcast center 237 may uplink command information to a terrestrial radio transmitter for local or metropolitan broadcasts. Alternatively, satellite radio terrestrial radio transmitters may receive radio signals from a geostationary satellite, amplify the signals, and rebroadcast the signals. Satellite broadcast messages may be transmitted once, periodically, or in another predefined sequence of time.

DSC receiver 236 receives DSC broadcast signals that have been processed by system 200. Such processed DSC signals may carry a unique identifier that indicates the signals may only be broadcast over certain channels, directing the DSC to certain receivers. In addition, such processed DSC signals carry a unique identifier that addressed the signals to DSC receivers at MVCU 110 and MVCU 210, if these MVCUs are members of the target fleet. When DSC sent from broadcast center 237 carries such identifiers, receiver 236 receives and processes the DSC, for example, by playing the DSC over speakers, over a visual display such as a liquid-crystal display (LCD), or other in-vehicle audio or visual device. A play-delay indicator may be included with the DSC to indicate to receiver 236 that the DSC may be stored in memory at the mobile vehicle. In an example, the user may not be present in the vehicle. The play delay indicator allows the DSC to be presented at a later time.

Digital content management system 200 may further comprise a DSC manager 238. DSC manager 238 may be the same component as communication services manager 174 or, as seen in FIG. 2, these two components may be separate.

DSC manager 238 is any suitable hardware and software capable of managing and scheduling DSC for broadcast to receiver 236 in MVCUs 110 or 210. Furthermore, DSC manager 238 is any suitable hardware or software capable of determining the members of a target fleet and processing the DSC to make it addressable to the target fleet. For example, DSC manager 238 may create a unique identifier associated with the target fleet and address the DSC with that identifier for transmission to target fleet DSC receivers 236. DSC manager 238 may also process DSC signals so that they are only broadcast over certain channels, further directing the DSC to target fleet receivers.

DSC manager 238 sends to or receives from one or more communication services databases 176. In one embodiment of the invention, DSC manager 238 specifically sends to or receives from DSC database 239.

In accordance with the present invention, DSC manager 238 may also receive DSC from satellite 146, from the client via computer 150, from a web-hosting portal 160, from a land network 144, and/or from DSC broadcast center 237. DSC manager 238 may also control the start period, indicating at what time the broadcast of the DSC should begin. DSC manager 238 may further control the duration, indicating how long the DSC should be broadcast. DSC manager 238 may also cause the DSC to be stored in a database, such as DSC database 239. DSC manager 238 may also determine for how long the DSC should be stored. DSC manager 238 may further determine if the DSC is expired and whether the DSC should be deleted after expiration. DSC manager 238 also checks the database 176, 239 to determine which content is scheduled for broadcasting.

DSC manager 238 may communicate with telematics unit 120 and receiver 236 in MVCUs 110 or 210 through satellite 146, DSC center 237, wireless carrier system 140, communication network 142, land network 144, voice and data switch 172, and network system 180. Although, as described above, DSC is generally broadcast from DSC center 237 to receiver 236, alternative networks such as wireless carrier system 140, communication network 142, land network 144, and network system 180 are also available for transmitting the DSC once processed by DSC manager 238.

As indicated above, DSC management system 200 may further comprise one or more databases 239 for storing DSC to be broadcast. In one embodiment of the invention, DSC database is the same component as communications services database 176. In a preferred embodiment, DSC database 239 is a separate dedicated database in communication with system 200. DSC database 239 stores such information as the actual DSC, the source of the DSC (e.g. direct from satellite, originally entered by a user at 170, enter by a user at 150, etc.). DSC database 239 also stores scheduled times for broadcasting the DSC as well as the durations indicated for broadcasting the DSC. DSC database 239 also stores the identifying information which indicates that MVCU 110 and/or 210 are members of the target fleet. DSC database 239 may also store security or encryption information for the DSC.

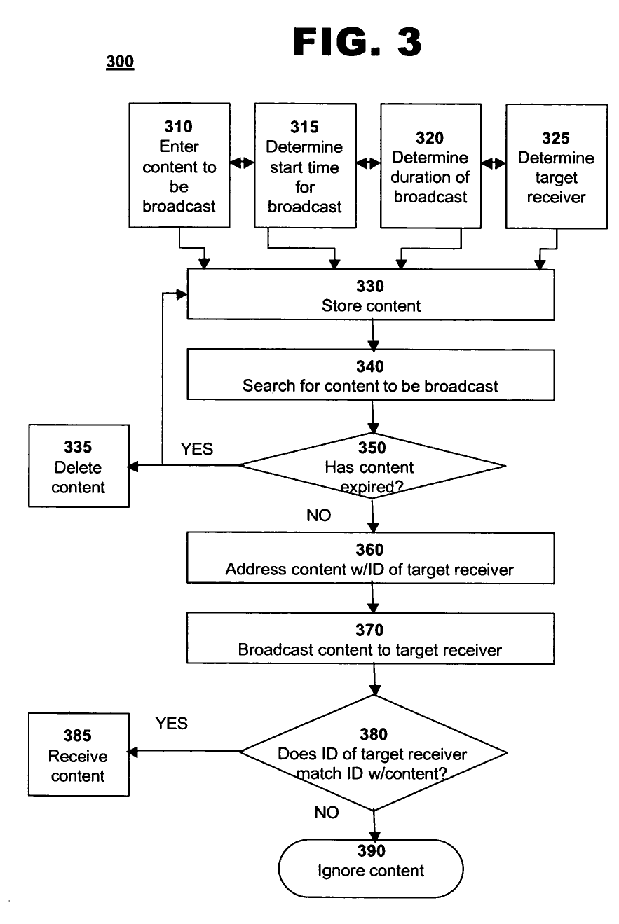

FIG. 3 illustrates a method 300 of managing DSC in a mobile vehicle communication system in accordance with one embodiment of the current invention. Although the steps described in method 300 are shown in a given order, the steps may be performed simultaneously and in a differing order from that illustrated.

DSC for broadcasting is entered, as seen at block 310. This content may be entered, for example, at a user interface as further illustrated in FIG. 4. Such an interface may be located, for example, at computer 150, on web hosting portal 160, at vehicle call center 170, at telematics unit 120 or at another mobile device (such as a mobile phone or PDA) connected to the mobile vehicle communication system. In another embodiment, the mobile phone or PDA communicates with the vehicle call center or web portal independent of the MVCS.

As seen at block 315, the start time for broadcasting the content may also be determined at the user interface.

As seen at block 320, the duration for broadcasting the content may also be determined at the user interface.

As seen at block 325, the mobile vehicle or vehicles to which the broadcast will be sent is also determined. This determination may be made, for example, by selection at the user interface or by entering information about the target mobile vehicle at the user interface. The determination may be based on parameters such as vehicle type, vehicle model, geographic region, point-of-sale dealership, garage location, or additional factory-installed equipment on the vehicle. Thus for example, the target fleet may comprise all vehicles in a particular fleet, such as a military fleet or a fleet of taxis (though the vehicle makes may all be different, the vehicles are identified as part of the same fleet). Alternatively, the target fleet may comprise all vehicles of the same make, such as all 2003 model Chevrolets that need a service update reminder message. Alternatively, the target fleet may comprise all vehicles in the same location, such as all vehicles currently in the Detroit area that could make use of a text message restaurant coupon. Alternatively, the target mobile vehicles may be vehicles targeted for a personal greeting, such as a birthday greeting, as entered by a subscriber.

As also illustrated at block 330, DSC gathered at steps 310, 315, 320 and 325 may be stored in DSC database 239 at any time during the procedure.

Once the content is stored in DSC database 239, DSC manager 238 checks the database 239 to determine what content should be broadcast, as seen at block 340.

Once DSC manager 238 has found DSC to be broadcast, manager 238 determines if the DSC has expired 350. Manager 238 makes this determination based on information gathered at steps 315 and 320. Manager 238 checks the start time of the broadcast, checks the duration of the broadcast and updates these figures each time it finds a specific content to be broadcast. In one embodiment of the invention, manager 238 reduces the duration of the broadcast time by one second each time it encounters the content. Thus the expiration time of the DSC may be calculated using an algorithm wherein the duration is added to the start time to determine an end time. The current time is then compared to the end time and if there is time remaining, the DSC remains active. If there is no time remaining, the DSC is marked as expired. Alternatively, as described below, a user of manager 238 may manually mark a message as expired.

If DSC has expired 350, DSC manager 238 may continue to store the DSC on database 239 or may delete the DSC as seen at block 335.

If the content has not expired 350, DSC manager 238 then addresses the content with information for identifying members of the target fleet as seen at block 360. The target receiver identification may be used to indicate an individual target mobile vehicle, an entire target group of mobile vehicles, one or more target mobile devices or one or more receivers 236 within a target vehicle or device.

Examples of the identification that could identify members of the target fleet include vehicle identification numbers, electronic serial numbers of a telematics unit within the mobile vehicle, a cell phone number of a telematics unit within the mobile vehicle, a satellite content receiver identification number associated with the DSC receiver 236 in the mobile vehicle, or a pre-assigned vehicle reference number stored within the mobile vehicle.

The content is then transmitted to one or more target DSC receivers as seen at block 370. This content may be broadcast via satellite broadcast center 237 as well as wireless carrier 140, communication network 142 or land network 144.

The addressed DSC is received at the DSC receiver to determine if there is an identification match as seen at block 380. A computer application running in the telematics unit 120 of a mobile vehicle may monitor one or more satellite-radio-system broadcast channels for a satellite broadcast message that includes the identification linked to the DSC. The satellite broadcast message is received, for example, with an in-vehicle satellite content receiver 236 from one or more satellite radio service geostationary satellites, a satellite radio broadcast satellite, or a terrestrial radio transmitter that amplifies and repeats signals received from a satellite radio broadcast satellite. The broadcast channel may be monitored for particular command strings or protocol, and the satellite content may be extracted for further processing when it is linked to a particular identification. Alternatively, the matching process may occur at the DSC broadcast center 237, with the DSC not being transmitted if no matches are found.

If a match is determined, the target receiver receives the DSC, as seen at block 385. The DSC may then be output to the user, for example, via a voice output, through speakers 132 or via an integrated navigation display. The user may store or delete the DSC. The user may also respond to the DSC. For example, the user may respond over wireless carrier 140, communication network 142 or land network 144.

If a match is not determined, the content is ignored by receiver 236 as seen at block 390.

FIG. 4 illustrates a user interface 400 for managing DSC, in accordance with the present invention. Such an interface may be located, for example, at computer 150, on web hosting portal 160, at vehicle call center 170, at telematics unit 120 or at another mobile device (such as a mobile phone or PDA) connected to the mobile vehicle communication system. User interface 400 may be available to many different types of users so that each user has the ability to broadcast content using satellite delivery.

User interface 400 includes a DSC entry area 410, into which DSC may be entered, for example in the form of text. This data may be keyed in or voice-dictated into entry area 410.

User interface 400 may also comprise a predetermined content entry area 415, in which users may select from a list of pre-determined content to be broadcast. As seen in FIG. 4, one embodiment of the invention uses a drop-down list as predetermined content entry area 415.

User interface 400 further comprises a duration-of-broadcast entry area 420 in which users may enter the duration of time over which they wish the DSC to be broadcast. As seen in FIG. 4, one embodiment of the invention uses a drop-down list as the duration-of-broadcast entry area 420. In another embodiment, the user may enter an arbitrary duration-of-broadcast entry.

User interface 400 may further comprise an attachment component 425. Attachment component 425 allows the user to attach further content to the DSC entered in area 410. User interface 400 may further comprise a display area 426 allowing the user to view a list of the active broadcasts.

User interface 400 may further comprise a manual expiration component 430. Manual expiration component 430 enables the user to manually stop broadcast of one or more active DSC broadcasts.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of managing digital satellite content for delivery to a target fleet, comprising:
identifying at least one member of the target fleet, the identified member in communication with a digital satellite content receiver;
determining digital satellite content to be transmitted to the target fleet;
addressing the digital satellite content to the identified member of the target fleet; and
transmitting the digital satellite content.

2. The method of claim 1, further comprising:
receiving the digital satellite content at the digital satellite content receiver.

3. The method of claim 1, further comprising:
storing the digital satellite content in a dedicated content broadcast database.

4. The method of claim 3, further comprising:
deleting the digital satellite content from the dedicated content broadcast database.

5. The method of claim 1 further comprising:
determining whether the transmitted digital satellite content is expired.

6. The method of claim 1, further comprising:
determining a start time for transmitting the digital satellite content.

7. The method of claim 1, further comprising:
determining a duration for transmitting the digital satellite content.

8. The method of claim 1 wherein addressing the digital satellite content comprises:
encoding the digital satellite content with an identifier that indicates the identified member.

9. A system for managing digital satellite content for delivery to a target fleet, comprising:
means for identifying at least one member of the target fleet, the identified member in communication with a digital satellite content receiver;
means for determining digital satellite content to be transmitted to the target fleet;
means for addressing the digital satellite content to the identified member of the target fleet; and
means for transmitting the digital satellite content.

10. The system of claim 9, further comprising:
means for receiving the digital satellite content at the digital satellite content receiver.

11. The system of claim 9, further comprising:
means for storing the digital satellite content in a dedicated content broadcast database.

12. The system of claim 9, further comprising:
means for determining whether the transmitted digital satellite content is expired.

13. The system of claim 9, further comprising:
means for encoding the digital satellite content with an identifier that indicates the identified member.

14. A computer usable medium including a program for managing digital satellite content for delivery to a target fleet, the program comprising:
computer program code that identifies at least one member of the target fleet, the identified member in communication with a digital satellite content receiver;
computer program code that determines digital satellite content to be transmitted to the target fleet;
computer program code that addresses the digital satellite content to the identified member of the target fleet; and
computer program code that transmits the digital satellite content.

15. The program of claim 14, further comprising:
computer program code that receives the digital satellite content at the digital satellite content receiver.

16. The program of claim 14, further comprising:
computer program code that stores the digital satellite content in a dedicated content broadcast database.

17. The program of claim 14 further comprising:
computer program code that determines whether the transmitted digital satellite content is expired.

18. The program of claim 14, further comprising:
computer program code that determines a start time for transmitting the digital satellite content.

19. The program of claim 14, further comprising:
computer program code that determines a duration for transmitting the digital satellite content.

20. The program of claim 14 further comprising:
computer program code that encodes the digital satellite content with an identifier that indicates the identified member.
